(19) United States
(12) Patent Application Publication
(10) Pub. No.: US 2025/0012246 A1
(43) Pub. Date: Jan. 9, 2025

(54) FUEL INJECTOR

(71) Applicant: LIEBHERR-COMPONENTS DEGGENDORF GMBH, Deggendorf (DE)

(72) Inventors: Martin SEIDL, Deggendorf (DE); Florian SCHILLER, Regen (DE); Johannes SEIDL, Niederalteich (DE)

(21) Appl. No.: 18/708,162

(22) PCT Filed: Nov. 8, 2022
(86) PCT No.: PCT/EP2022/081078

§ 371 Date: May 7, 2024

(30) Foreign Application Priority Data
Nov. 8, 2021 (DE) 10 2021 129 011.2

(51) Int. Cl. F02M 55/04; F02M 55/02; F02M 61/10; F02M 61/18

(52) U.S. Cl. CPC F02M 55/04; F02M 55/02; F02M 61/10; F02M 61/1886

(57) ABSTRACT

The present invention relates to a fuel injector for injecting a fuel into a combustion chamber of an internal combustion engine, which comprises a feed opening for feeding in fuel, at least one outlet opening for outputting the fuel, a nozzle needle which is movable between a closed position, in which the at least one outlet opening is closed, and an open position, in which the at least one outlet opening is opened, and a primary valve which is arranged downstream of the feed opening and upstream of the nozzle needle and is designed to establish a fluid connection between the feed opening and the nozzle needle only when a positive pressure is exceeded by a region upstream of the primary valve with respect to a region downstream of the primary valve.

The present invention relates to an injector for injecting fuel.

In internal combustion engines such as diesel engines or petrol engines, fuel is usually injected into a combustion chamber via an injector in a certain quantity and for a certain period of time. Due to the very short injection times, which are in the microsecond to millisecond range, it is necessary to open and close the outlet opening of the injector at a very high frequency.

An injector typically has a nozzle needle (also known as an injector needle) that allows a highly pressurised fuel to escape when an outlet hole in the injector is released. In conjunction with this outlet opening or the injector housing, this nozzle needle acts as a seal that allows the fuel to escape when it is lifted. It is therefore necessary to lift this needle at relatively short intervals and allow it to slide back into its closed position after a short time. Hydraulic servo valves can be used to trigger this movement. Such valves are typically actuated with the aid of an electromagnet or a piezo element.

In addition, it is advantageous if an injector connected to a high-pressure line has a pressure relief valve or is connected to one that prevents fuel from flowing into the injector up to a certain overpressure.

This prevents fuel from entering the injector in standby mode (maintenance mode), for example, during which the fuel lines leading to the injector, to which the injector is connected, are cleaned by flushing. In addition, the pressure relief valve function prevents unintentional and uncontrolled injection into the combustion chamber or even flooding of the combustion chamber in the event of a fault with a permanently open, blocked nozzle needle, which could lead to serious damage when the engine is started. This sealing function can be realised by means of a pressure relief valve (PRV), wherein the pressure relief valve only opens at a certain overpressure from the rail (or the fuel line leading to the injector) to the injector and is otherwise closed.

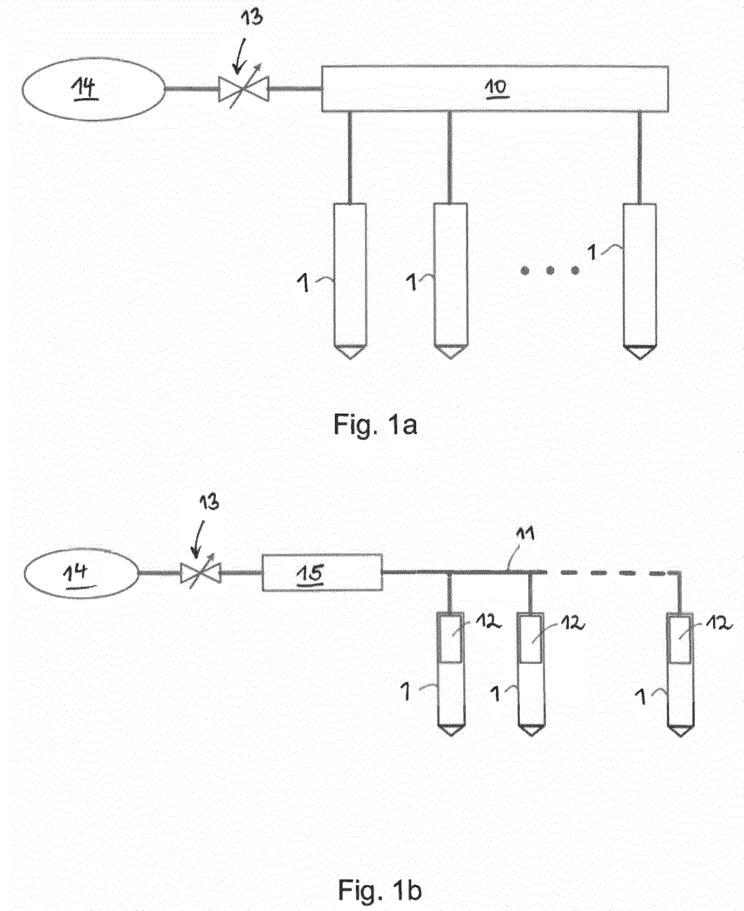

Typically, one or more injectors are installed in an engine or on a test bench. These are either connected to a common high-pressure volume and thus indirectly connected to each other (see FIG. 1a) or, in the case of a plurality of injectors, can be directly connected to each other via fuel lines (see FIG. 1b). In this case, the injectors themselves generally each contain a high-pressure storage volume (pressure reservoir), which they share with the other injectors via the connection through the fuel lines (see FIG. 1b). The pressure storage volume is used to dampen pressure oscillations and to maintain the system pressure during injection.

To depressurise the test bench or engine, a pressure release valve is fitted to the common high-pressure volume (e.g. rail), which can be actively controlled and allows the fuel to flow from the high-pressure volume into the tank. The pressure release valve can be activated after the engine or test bench has been switched off, for example, in order to achieve a safe, depressurised state so that maintenance work can be carried out on the depressurised system afterwards, for example.

The problem here, however, is that when a pressure release valve (located on the rail, for example) is actuated, the pressure relief valve (which is designed to block in the direction from the injector to the feeding fuel line) creates an extremely large pressure difference across components in the injector, which can lead to component damage in the injector and is considered disadvantageous in terms of safety. Finally, due to the high tightness of the injector components, it takes a very long time for the high pressure difference to be reduced via an actually undesired leakage. Only then is it safe for maintenance personnel to work on the injector.

The aim of the present invention is to provide a fuel injector that overcomes or mitigates the disadvantages listed above. This is achieved with a fuel injector that has all the features of claim 1. Advantageous embodiments can be found in the dependent claims.

Consequently, it is provided that a fuel injector according to the invention for injecting a fuel into a combustion chamber of an internal combustion engine, in particular a diesel engine, comprises a feed opening for feeding in fuel, at least one outlet opening for outputting the fuel, a nozzle needle which is movable between a closed position, in which the at least one outlet opening is closed, and an open position, in which the at least one outlet opening is opened, and a primary valve which is arranged downstream of the feed opening and upstream of the nozzle needle and is designed to establish a fluid connection between the feed opening and the nozzle needle only when a positive pressure is exceeded by a region upstream of the primary valve with respect to a region downstream of the primary valve. The fuel injector is characterized by a safety valve which is arranged downstream of the feed opening and upstream of the nozzle needle and is designed to establish a fluid connection between the feed opening and the nozzle needle only when a positive pressure is exceeded by a region downstream of the safety valve with respect to a region upstream of the safety valve.

The primary valve is therefore open or moves to its opened position when the pressure in the area of the feed opening is greater than the pressure in the area of the nozzle needle by a predetermined threshold value. The reverse is true for the safety valve, as it switches to its opened position when the pressure in the area of the feed opening is lower than the pressure in the area of the nozzle needle by a predetermined threshold value.

In addition to the primary valve, which acts as a pressure relief valve and only allows fuel to flow from a fuel supply line into the injector if a certain overpressure prevails, a safety valve is also provided, which acts in the opposite direction to the pressure relief valve (primary valve).

This means that when the pressure release valve arranged on the rail is actuated, the condition inside the injector in which a very high pressure difference occurs can be avoided. If the pressure inside the injector exceeds a certain threshold value compared to the pressure at the feed opening of the injector, which is fluidically connected to the fuel supply line, the safety valve ensures that the pressure difference is reduced in a controlled manner. Finally, the safety valve is opened so that the pressure can escape in the direction of the feed opening. By providing the safety valve, it is possible to work safely with the injector immediately after actuating the pressure release valve arranged on the rail, for example, as the injector no longer has any highly pressurised chambers.

According to a further optional modification of the present invention, it may be provided that the primary valve comprises a movable primary valve body, a primary valve seat sealable by the primary valve body and a resilient biasing element for urging the primary valve body towards the primary valve seat, and/or the safety valve comprises a movable safety valve body, a safety valve seat sealable by the safety valve body and a resilient biasing element for urging the safety valve body towards the safety valve seat.

The sealing effect produced by a valve is created by the valve body interacting with the valve seat and thus closing a feed-through so that a fluid connection running through the closed feed-through is interrupted by the valve. The valve body is typically arranged movably in the injector and is pushed towards the valve seat by an elastic clamping element. Depending on the prevailing pressure conditions upstream or downstream of the valve body, this causes the valve to open or close. If the pressure conditions upstream and downstream of the valve body are identical, the elastic clamping element ensures that the valve body moves in the direction of the valve seat, which leads to the valve closing. If the pressure conditions change in such a way that the force exerted by the elastic clamping element is increased, the valve remains in its closed position. If the pressure conditions are reversed, the valve body is forced out of its sealing position with the valve seat when the force exerted by the elastic clamping element has been overcome.

According to an advantageous modification of the present invention, it can be provided that the primary valve seat is arranged on a stop part that has at least one feed-through that can be closed or released by the primary valve body, and wherein the stop part has at least one second feed-through that cannot be closed by the primary valve body and that can only be closed or released by means of the safety valve.

The stop part can be rigidly connected to an injector housing.

After further development, the stop part, which has the primary valve seat, also has a further feed-through that cannot be closed by the primary valve body and can be closed or released by the safety valve. The operating directions of the primary valve and the safety valve are aligned in opposite directions so that the desired functions are realised. This additional feed-through is sealed exclusively by the safety valve. The primary valve cannot act on this.

According to a further optional embodiment of the present invention, it may be provided that the safety valve is integrated into the stop part, cooperates with it and/or forms it in conjunction with an elastic clamping element.

For example, the safety valve can be integrated into the stop part by defining the movement path of the safety valve body in a recess in the stop part. Furthermore, it can also be provided that the safety valve seat, which can be closed or released by the safety valve body, is arranged inside the stop part.

Alternatively or additionally, it is also possible that the safety valve body is not arranged inside the stop part, but cooperates with the outside of the stop part.

It can also be provided that the safety valve body has a feed-through that can be opened or closed by the primary valve body. In addition, the safety valve body can have at least one further feed-through that, when the safety valve body is positioned accordingly in the injector, can be closed or opened by a flange-like element that is rigidly connected to the injector housing. In particular, in such a configuration, it is advantageous if the force of the elastic clamping element acting on the safety valve body is greater than the force exerted by the other elastic clamping element on the primary valve body.

According to an optional modification of the present invention, it may be provided that the safety valve generates a sealing effect by means of a safety valve body in the form of a ball and a safety valve seat designed as a ball seat or conical seat, and/or the safety valve generates a sealing effect by means of a safety valve body in the form of a cone and a safety valve seat designed as a conical seat. The combination of the safety valve body in the form of a ball together with a conical seat is also possible.

The harmonised shape of the valve body and valve seat of the safety valve in the form of a ball or cone enables a simple and particularly effective seal that can be implemented with low maintenance.

According to a further embodiment of the present invention, it may be provided that the safety valve body is designed in one, two or more parts.

For example, the safety valve body can be formed only by a ball or by a ball and a forcing element that interacts with the ball and to which the elastic clamping element is attached. The forcing element can be firmly connected to the ball or a cone, although this is not mandatory. Especially for the design with a ball, it is not absolutely necessary for the connection to the forcing element to be fixed.

According to a further advantageous embodiment of the present invention, it may be provided that the primary valve body and/or the safety valve body is/are formed in one piece. In order to allow corresponding pressure differences for movement of the valve body in the injector, the valve body has at least one feed-through.

According to an advantageous modification of the present invention, it can be provided that the clamping element of the primary valve forces the primary valve body in a direction opposite to that in which the clamping element of the safety valve forces the safety valve body, wherein preferably the two directions are aligned antiparallel to each other.

Furthermore, according to the present invention, it may be provided that the safety valve is arranged upstream of the primary valve.

According to a further optional modification of the present invention, it may be provided that the secondary valve is arranged in the primary valve, preferably in that the primary valve body has a passage (e.g. at least one bore) that can be fluidically blocked by the secondary valve. In an unblocked state, the passage is able to bypass the primary valve, whereas in a blocked state, bypassing is not possible. For this purpose, the passage arranged in the primary valve body is designed in an unblocked state to create a fluid connection to the feed opening of the injector with an area downstream of the primary valve.

According to an optional further development of the present invention, it can be provided that the primary valve body is in contact with the safety valve body in a closed position, in which its associated resilient clamping element forces it, and seals a feed-through of the safety valve body, wherein preferably the clamping element of the primary valve and the clamping element of the safety valve each exert a force to press the primary valve body and the safety valve body against each other, wherein more preferably the force exerted by the clamping element of the safety valve is greater than that of the clamping element of the primary valve.

According to the invention, it can further be provided that the primary valve is further configured to restrict a flow of a fuel introduced from the feed opening towards the at least one outlet opening, preferably wherein the outflow of fuel downstream of the primary valve results in a pressure gradient being created to move a primary valve body in a direction opposite to its valve seat so that it comes into contact with a second downstream valve seat and stops the flow from the feed opening to the at least one outlet opening.

Accordingly, the primary valve body is therefore arranged between two different primary valve seats, wherein it can only be in contact with one of them at any given time. The time it takes for the primary valve body to move from its initial closing position, into which it is forced by the elastic clamping element, to the second primary valve seat under corresponding pressure conditions is decisive for limiting the flow rate. The number and diameter of the feed-throughs through the primary valve body through which the fuel is fed must also be taken into account for the flow rate.

According to an optional modification of the present invention, it may be provided that the injector has a pressure reservoir in which the primary valve is arranged. Preferably, the primary valve can be arranged in the downstream half, preferably in the downstream third of the pressure reservoir. The pressure reservoir is connected at its end opposite the fuel supply via a high-pressure connection to an area in which the switching valve including the nozzle needle is located.

According to an optional further development of the present invention, it is provided that the primary valve body and/or the safety valve body has at least one feed-through for passing fuel from an upstream section to a downstream section or vice versa.

Furthermore, it can be provided that the at least one feed-through for passing fuel of the primary valve body is arranged offset to the associated elastic clamping element, preferably such that a fluid flow flowing through the feed-through is not guided through windings of the elastic clamping element.

This has the advantage that there is no undesirable turbulence in the fluid flow, which would otherwise occur if the fluid flow were to cross the windings of the elastic clamping element.

The present invention also relates to an internal combustion engine, in particular for diesel and/or petrol, having at least one fuel injector according to any one of the preceding claims.

In particular, it can be provided here that a plurality of fuel injectors is connected to a common high-pressure volume and thus indirectly connected to one another.

It can also be provided that a plurality of fuel injectors is directly connected to one another via fuel lines and each have a high-pressure storage volume, which they share with the other injectors via the connection through the fuel lines.

Further features, details and advantages of the invention can be seen in the following description of the figures. In the figures:

FIGS. 1a/b: show schematic sketch of a fuel injector connection to a fuel accumulator,

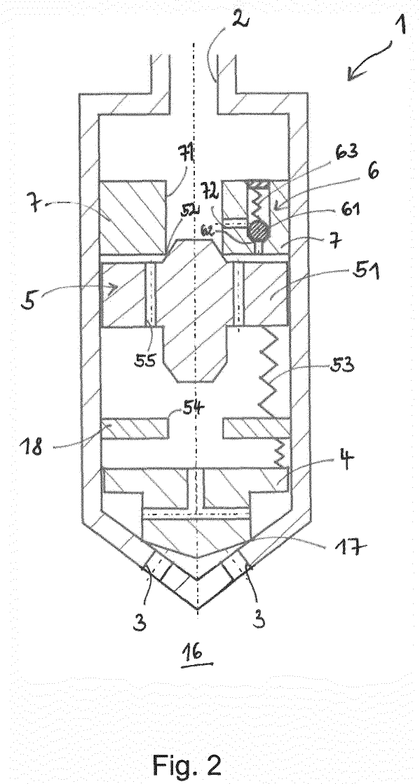

FIG. 2: shows a schematic sketch of a fuel injector according to the invention,

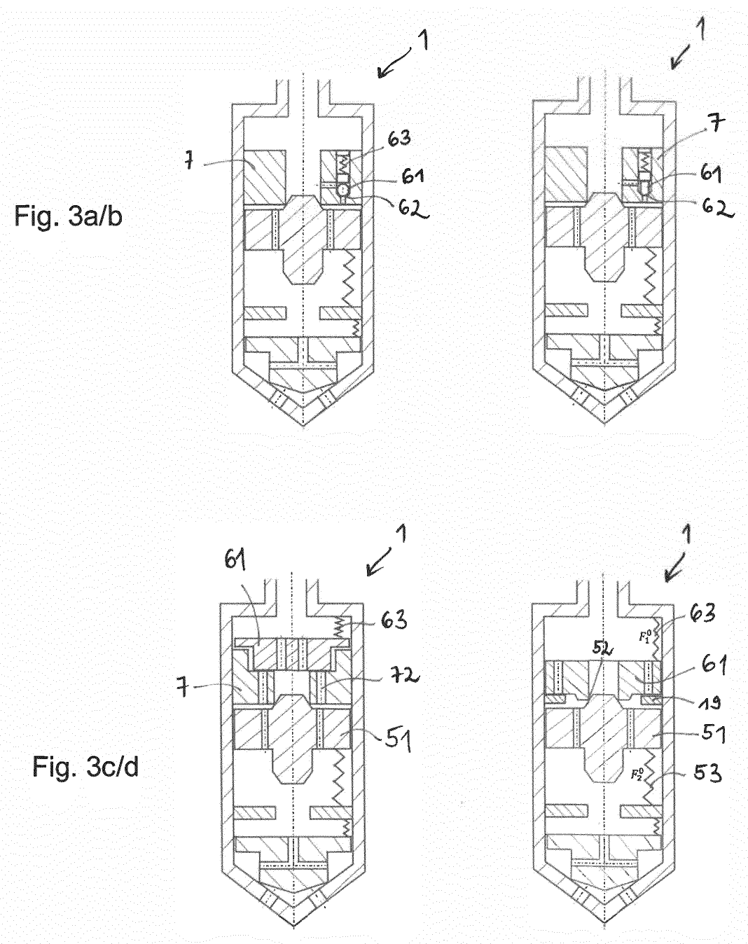

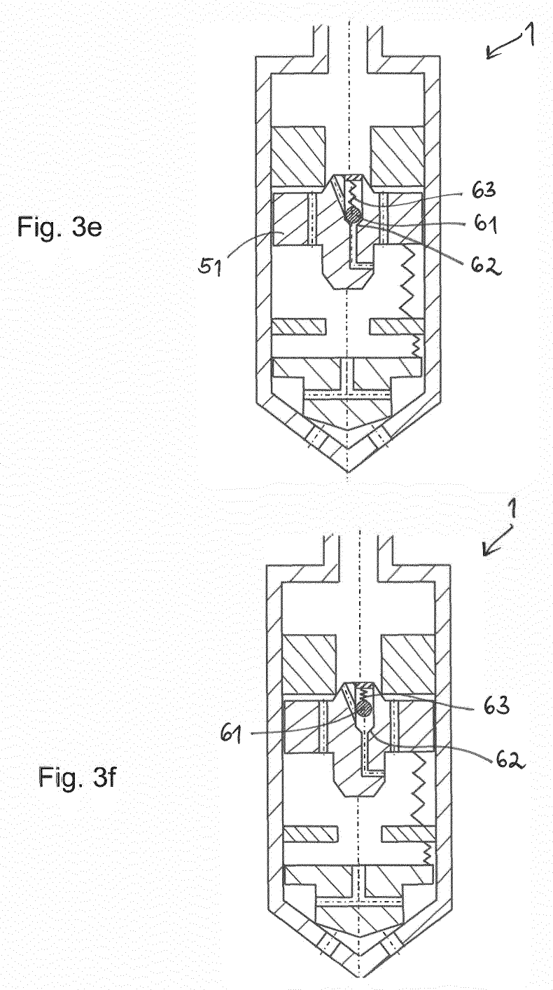

FIGS. 3a-f: show schematic sketches of different exemplary embodiments of the fuel injector according to the invention,

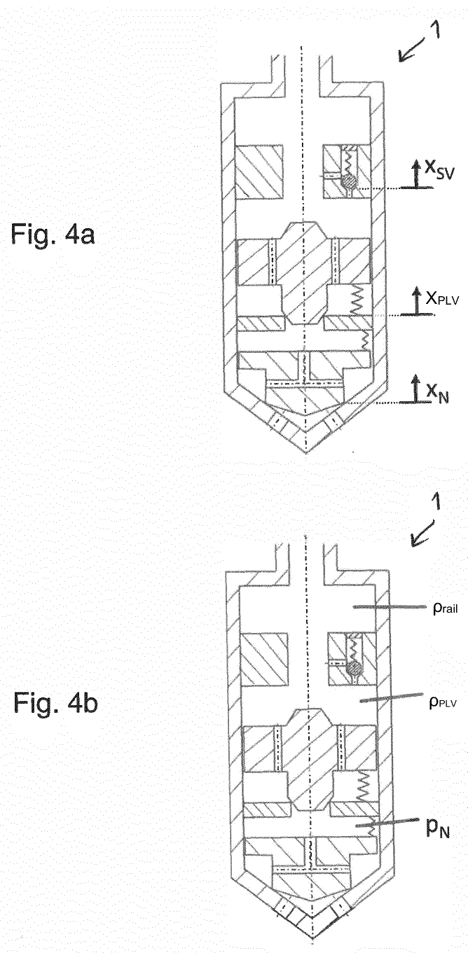

FIGS. 4a/b: show schematic sketches of the fuel injector with designations of the coordinate systems and the different pressure ranges,

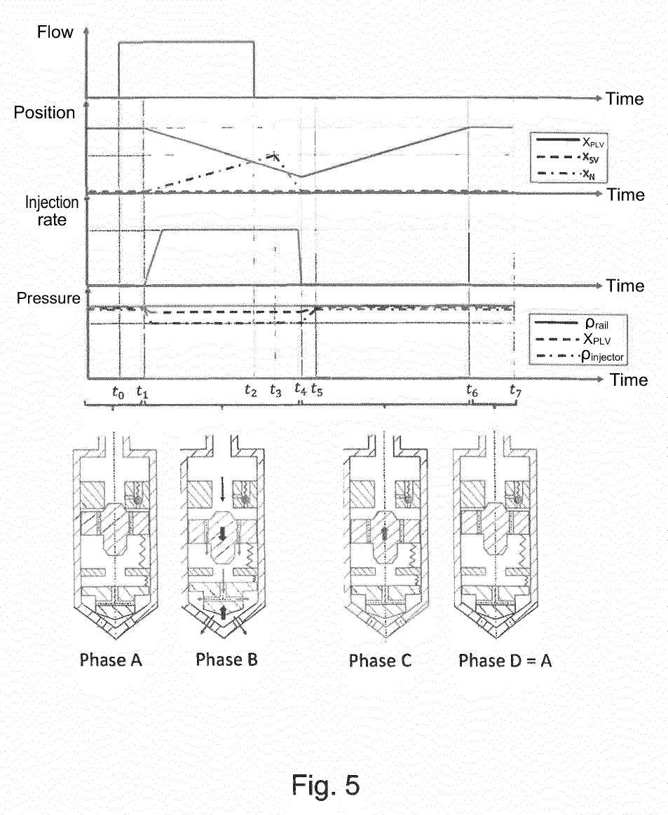

FIG. 5: shows an explanatory illustration when the fuel injector is running at normal full load injection,

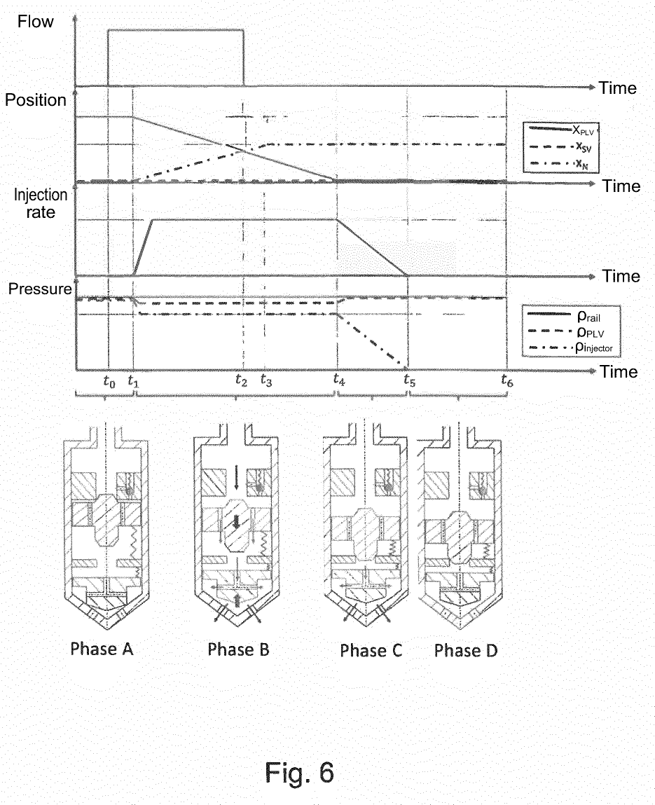

FIG. 6: shows an explanatory illustration of the injection of the fuel injector in the event of a needle jamming fault,

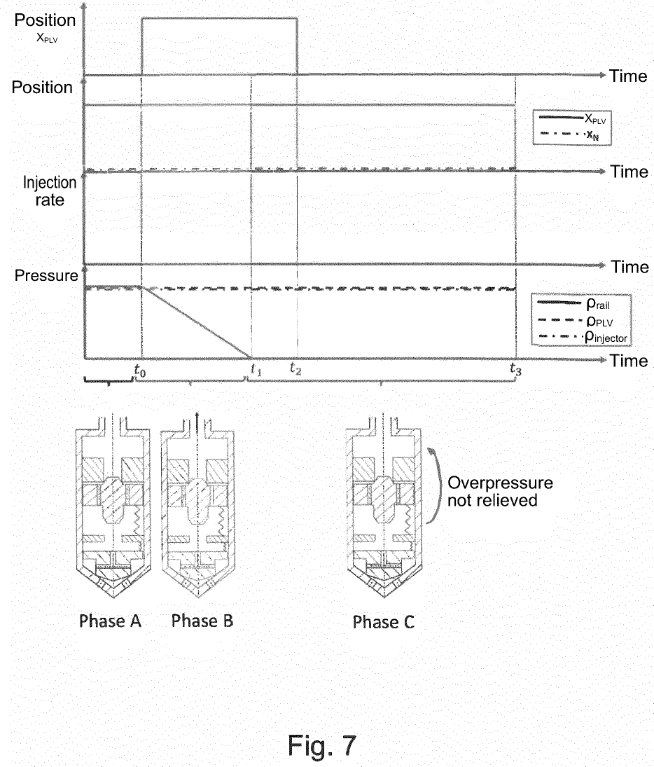

FIG. 7 shows an explanatory illustration of the fuel injector without a safety valve according to the invention,

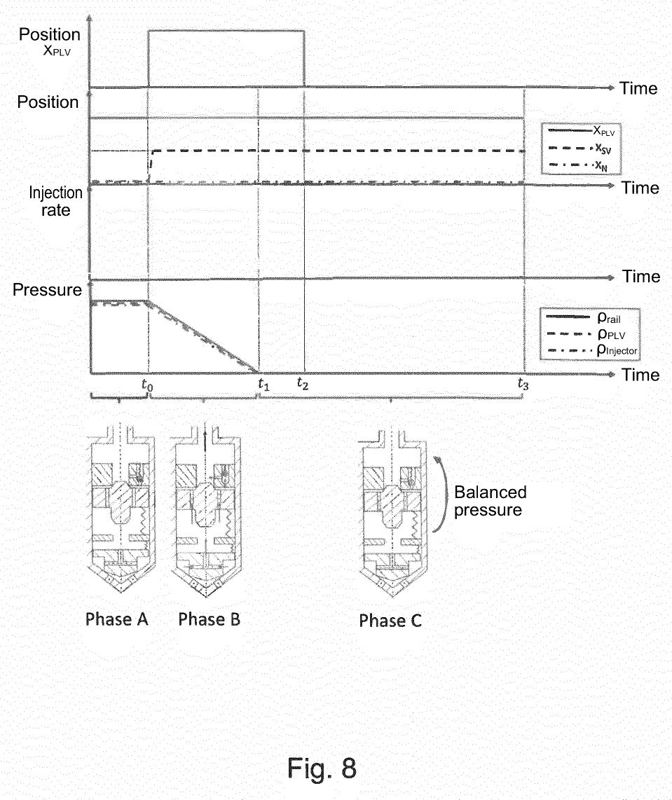

FIG. 8 shows an explanatory illustration of the fuel injector with a safety valve according to the invention,

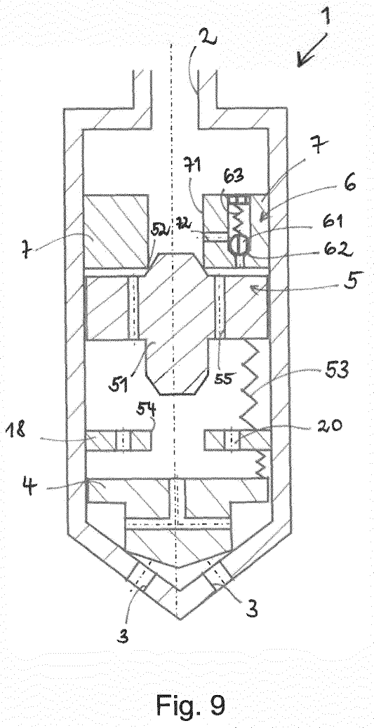

FIG. 9: shows a schematic sketch of a fuel injector according to the invention in which a fuel limitation is not provided,

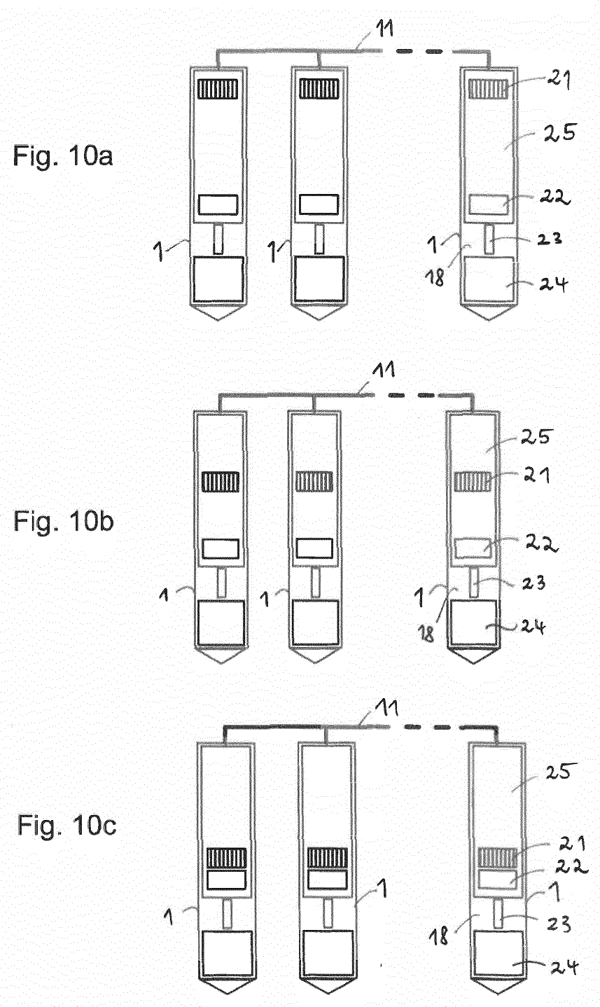

FIGS. 10a-d: show schematic sketches with different arrangement positions of the pressure relief valve and the flow limiting valve in the fuel injector, and

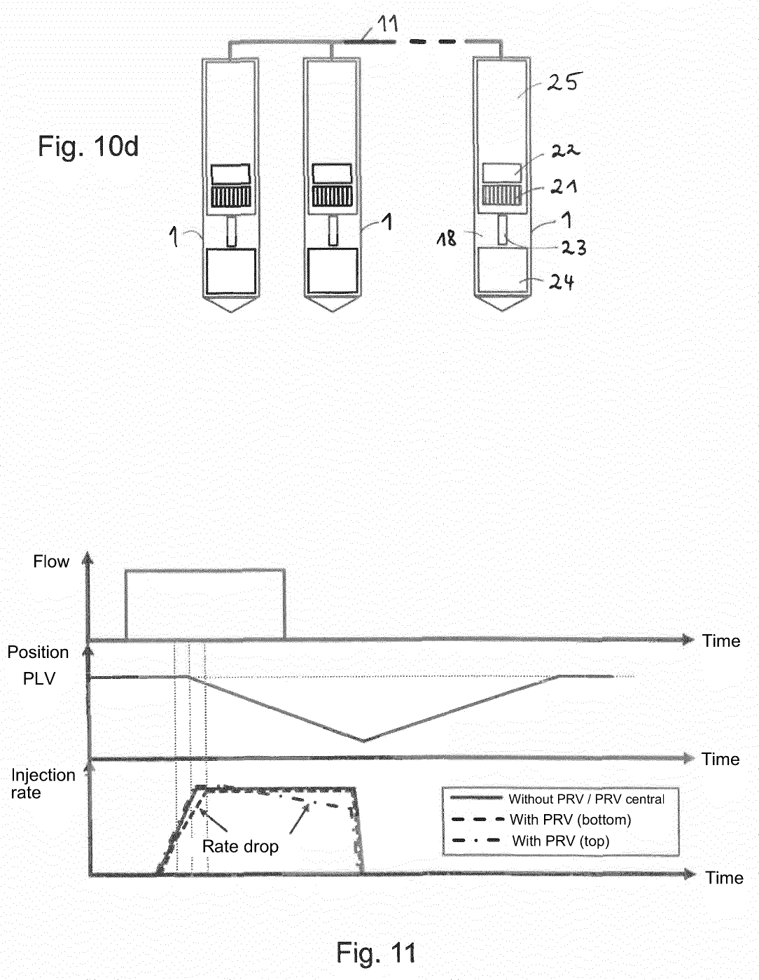

FIG. 11: shows a diagram to illustrate the differences in the different arrangement positions of the pressure relief valve in the fuel injector.

FIG. 1a shows a schematic sketch for connecting fuel injectors to a fuel supply system.

One or more injectors 1 are installed on a test bench or in an engine. These are connected to a common high-pressure volume 10 (e.g. a rail) and are thus indirectly connected to each other.

To depressurise the engine or the test bench, a pressure release valve 13 is fitted to the common high-pressure volume 10, which can be actively controlled and allows the fuel to flow from the high-pressure volume 10 or from the injectors into a tank 14. The pressure release valve can be activated after switching off the test bench or engine, for example, in order to be able to carry out maintenance work on the depressurised system afterwards.

FIG. 1b, on the other hand, shows a different configuration for the fuel supply, in which the injectors 1 are connected directly to each other via fuel lines 11. In this case, the injectors 1 generally each contain a high-pressure storage volume 12 (for example a pressure reservoir), which they share with the other injectors 1 via the connection through the fuel lines 11. The pressure storage volume 12 is used to dampen pressure oscillations and to maintain the system pressure during injection. As shown in FIG. 1b, in addition to the high-pressure storage volume 12, which is present in each injector 1, there may also be a common storage volume 15, which can be connected to the tank 14 via a pressure release valve 13. Here too, the high pressure in the storage volume 12 or storage volume 15 can be brought to normal level by opening the pressure release valve 13, as it is possible for the pressurised fuel to flow back into the tank 14.

FIG. 2 shows a sectional representation of an injector 1 according to the invention.

The injector 1 comprises a housing and contains an actively actuated switching valve (not shown, indirectly driven hydraulic valve or directly driven piezo valve), which closes or releases at least one connection between the injector volume and combustion chamber 16 via a nozzle needle seat 17 by means of a translationally movable nozzle needle 4.

The fuel is supplied to the injector 1 via a high-pressure connection 2 and fed inside the injector 1 to the nozzle needle seat 17 of the switching valve via a high-pressure connection.

In addition, the injector includes a primary valve 5 for implementing the flow limitation and enabling safe flushing of the fuel lines or storage volumes 10, 15 leading to the injector 1, which in the embodiment shown is capable of limiting the flow of fuel flowing through the injector 1 and at the same time only allowing fuel to flow into the injector 1 if there is a certain overpressure in the supplying fuel line in relation to the areas downstream of the primary valve 5.

In order to also fulfil the function whereby no very high pressure drop remains inside the injector when the fuel supply line is reset to a depressurised state, a safety valve 6 is also provided, which acts in the opposite direction to the overpressure valve function of the primary valve 5.

Both the primary valve body 51 and the safety valve body 61 can be moved in translation and close or open a feed-through 71, 72.

In an initial position in which the pressure in the injector 1 is the same everywhere, respective elastic clamping elements 53, 63 ensure that the primary valve body 51 or the safety valve body 61 are pushed in the direction of their respective valve seat 52, 62. If there is now a sudden drop in pressure due to a lifting of the nozzle needle 4, the pressure downstream of the primary valve body 51 decreases, causing the primary valve body 51 to lift out of the valve seat 52. The feed-throughs 55 provided in the primary valve body 51 allow a certain flow of fuel, but cannot equalise the prevailing pressure conditions when the injector is open. In a regular injection cycle, the needle 4 is returned to its sealing position before the primary valve body 51 touches the second stop 18, which is arranged downstream of the first stop 7. Contact between the primary valve body 51 and the second valve seat 54 at the second stop 18 only occurs in the event of a fault, i.e. if the nozzle needle 4 remains in the open position for an unexpectedly long time. This prevents a continuous flow of fuel from the injector 1, which could cause serious damage to the combustion chamber 16.

If, on the other hand, the pressure in the fuel supply line is reduced (for example by actuating a pressure release valve 13 as shown in FIG. 1a or FIG. 1b) in the starting position shown in FIG. 2, in which fuel is present everywhere in the injector at high pressure, the pressure in the area downstream of the primary valve body 51 is equalised via the safety valve 6. The fuel under high pressure can escape towards the fuel supply line via the feed-through 72 by means of the safety valve seat, so that there are no longer any areas in the injector 1 where fuel is stored under very high pressure.

In the embodiment of the injector 1 shown in FIG. 2, the function of the flow limitation and the functionality of the pressure relief valve are implemented as a combined functionality in the primary valve 5. However, the invention also comprises the fact that these two functionalities are embodied in different valves, which are arranged at different positions in the flow path of the injector 1.

FIGS. 3a-d each show different embodiments of the injector 1 according to the invention. To improve clarity, not all the reference numerals known from FIG. 2 have been re-inserted into the illustrations in FIGS. 3a-d.

FIG. 3a shows an implementation of the injector 1 in which the safety valve body is designed in two parts. In the present case, the safety valve body 61 comprises a ball that can be moved in translation together with a (cylindrical) element inside the stop part 7. The elastic clamping element 63 is in contact with the (cylindrical) element, which in turn pushes the ball in the desired direction. The safety valve seat 62 is adapted to the spherical shape of the safety valve body 61 and can therefore also be realised as a spherical seat.

FIG. 3b shows a realisation of the safety valve body 61 using a conical shape, wherein the safety valve 6 is arranged inside the stop part 7. The corresponding safety valve seat 62 can be a conical seat.

FIG. 3c shows a further embodiment of the injector 1 according to the invention. Unlike the implementations of the injector 1 discussed above, the safety valve body 61 is no longer arranged inside the stop part 7. The stop part 7 is now arranged between the primary valve body 51 and the safety valve body 61. The safety valve 6 is provided upstream and the primary valve 5 is provided downstream. Both the primary valve body 51 and the safety valve body 61 have at least one feed-through that cannot be closed regardless of an actuation and an arrangement position of the associated valve body 51, 61. In addition, the stop part has at least two feed-throughs, the first of which can be closed by the primary valve 5 and the second by the safety valve 6. The embodiment shown in FIG. 3c allows for larger components, in particular with regard to the safety valve body 61, which simplifies assembly and also manufacture.

FIG. 3d is a further development of the embodiments considered above, which is optimised in its installation height and yet avoids the use of small components inside the stop part 7.

As can be seen in FIG. 3d, there is now no longer a stop part 7 that is rigidly connected to the housing and the feed-through of which can be closed by the primary valve 5. In the present case, its function is assumed by the translationally movable safety valve body 61. The safety valve body 61 has a feed-through that can be sealed by the primary valve body 51 when the safety valve body 61 is in a corresponding position by the primary valve body 51 coming into direct contact with the safety valve body 61. The primary valve seat 52 is therefore arranged on the safety valve body 61. In addition, the safety valve body 61 has at least one further feed-through that can be sealed with a modified stop part 19, wherein the stop part 19 has no feed-through, in particular no feed-through that can be sealed by the primary valve body 51. Advantageously, the force of the elastic clamping element 53 acting on the primary valve body 51 is lower than the force of the elastic clamping element 63 acting on the safety valve body 61.

FIG. 3e shows an embodiment in which the safety valve 6 is integrated in the primary valve 7. The primary valve body 51 has a passage that can be closed by the secondary valve. FIG. 3e shows the state in which the secondary valve 6 closes the passage running through the primary valve body 51. A spring 63 pushes the secondary valve body 61 into a closing position so that the passage running through the primary valve body 51 is fluidically blocked.

FIG. 3f, on the other hand, shows a state in which the feed-through running through the primary valve body 51 is not fluidically blocked by the secondary valve body 61. It is therefore possible for pressure equalisation to take place downstream of the primary valve 5 to an area upstream of the primary valve 5, even though the primary valve body 51 is in its closed position.

The functional behaviour of the injector 1 is described below for different scenarios. The initial situation is the same in all cases and is based on FIG. 2. The switching valve (not shown) with the nozzle needle 4 is closed, i.e. the nozzle needle 4 closes the connection between the injector 1 and the combustion chamber 16 by sealing in the nozzle needle seat 17. The rail pressure βᵣₐᵢₗ is present in the entire high-pressure area of the injector 1 and in the rail 10. The primary valve body 51 is preloaded by the spring 53 and is located at its upper stop 52 and thus seals the injector 1 against the rail 10 in its simultaneous function as a pressure relief valve. The safety valve body 61 is preloaded by the associated spring 63 and is located in its stop on the safety valve seat 62. It also seals the injector 1 against the rail 10.

FIG. 4a and FIG. 4b show the coordinate systems of the moving parts and the reference spaces for the pressures listed, as described in the diagrams in FIGS. 5-8 below.

FIG. 5 shows a diagram and the corresponding movement of the components in the injector for a normal injection under full load.

### Phase A: Primary Valve Body in Upper Stop

At time t0, an actuation signal is sent to the injector 1, so that at time t1 the nozzle needle 4 begins to move out of the seat 17 and releases the connection between the injector 1 and the combustion chamber 16. Injection begins. The pressure downstream of the primary valve body 51 decreases and the primary valve body 51 begins to move downwards (with a slight delay, not shown here).

### Phase B: Primary Valve Body Moves Downwards

At time t2, the actuation signal of the switching valve (not shown) is terminated and the nozzle needle 4 then returns to its original position in the seal seat 17 (t3-t4). Injection thus ends at time t4. The primary valve body 51 moves downwards during the entire injection process due to the pressure difference prevailing across the primary valve 5, which can be adjusted by the size and number of throttle holes 55 in the primary valve body 51.

### Phase C: Primary Valve Body Moves Upwards

After injection, the injector 1 fills up with fuel again. This equalises the pressure in the primary valve 5 so that the primary valve body 51 is returned upwards to its upper stop 52 by the elastic clamping element 53 (t4-t6). (In reality, the reversal point of the primary valve body 51 is slightly offset in time approximately between t4 and t5 due to the inertia, but this is not shown here). The primary valve body 51 always maintains a safety distance from the lower stop 18 in order to prevent unintentional closing of the primary valve 5 during normal injection.

### Phase D: Initial State at the Beginning of Phase A is Reached Again

The primary valve body 51 reaches the upper stop at time t6. All mechanical components and pressures have returned to their original state (t6-t7).

FIG. 6 shows a diagram and the corresponding movement of the components in the injector for the fault case of a jammed nozzle needle 4.

### Phase A: Primary Valve Body in Upper Stop

Phase A is identical to the “normal injection (full load)” case shown in FIG. 5. At time t0, an actuation signal is sent to the injector, so that at time t1 the nozzle needle 4 begins to move out of the seat 17 and releases the connection between the injector 1 and the combustion chamber 16. Injection begins. The pressure downstream of the primary valve body 51 decreases and the primary valve body 51 begins to move downwards (with a slight delay, not shown here).

### Phase B: Primary Valve Body Moves Downwards

Phase B initially begins identically to the “normal injection (full load)” case shown in FIG. 5. At time t2, the actuation signal of the switching valve (not shown) is terminated. Now, however, the nozzle needle 4 remains fixed in its opened position due to a fault. This can occur, for example, due to a direct jamming of the nozzle needle or due to a malfunction of an upstream hydraulic valve (t3-t6). This results in continuous injection with a quantity of fuel entering the combustion chamber in excess of the full load quantity, which can cause very serious damage to the combustion chamber. Without a flow restriction, the continuous introduction of fuel would lead to engine damage.

In contrast to the “normal injection (full load)” case (see FIG. 5), the primary valve body 51 now continues to move downwards until it strikes the seat 54 at the lower stop 18 at time t4 and then blocks the flow of fuel (possibly after a brief bounce).

### Phase C: Primary Valve Body Remains in Lower Stop

As soon as the primary valve body 51 closes the lower sealing seat, the remaining quantity of fuel downstream of the primary valve body 51 is still introduced into the combustion chamber 16 until the pressure in the injector 1 downstream of the primary valve body 51 has equalised with the pressure in the combustion chamber 16 (t4-t5). The pressure upstream of the second stop 18 equalises with the fuel pressure again.

### Phase D: End State is Reached

The primary valve body 51 remains in the lower stop due to the applied pressure difference and continues to prevent the fuel from flowing from the fuel supply into the injector (t5-t6).

FIG. 7 shows a diagram and the corresponding movement of the components in the injector, which is designed without a safety valve 6.

### Phase A: Initial State Before/after Normal Injection

At time t0, all components and pressures are in their initial state before or after normal injection.

### Phase B: Pressure Release of the Rail

The rail 10 or the common high-pressure storage volume 12, 15 of the injectors is relieved of high pressure by switching a pressure release valve 13 connected to the rail 10, for example, at time to, via which the fuel is returned from the rail 10 to the tank 14. As a result, the pressure in the rail 10 generally drops to the tank pressure (ambient pressure) at time t1 within a very short time (a few milliseconds).

If there is no safety valve 6, the primary valve 5 (here also the pressure relief valve and the flow limiting valve) blocks the outflow of fuel from the injector 1 into the rail 10 back to the tank 14 at the upper stop 52. As a result, an extremely high pressure difference equal to the previously prevailing fuel pressure is built up via the upper stop part of the primary valve 5.

### Phase C: End State Reached

The high pressure difference does not reduce or only reduces extremely slowly (t>>t1). On the one hand, this can lead to component damage inside the injector 1. On the other hand, this poses a considerable danger to people when dismantling the injector 1.

FIG. 8 shows a diagram and the corresponding movement of the components in an injector 1 according to the invention, which has a safety valve 6.

### Phase A: Initial State Before/after Normal Injection

This phase is the same as the case without a safety valve, which is shown in FIG. 7.

At time t0, all components and pressures are in their initial state before or after normal injection.

### Phase B: Pressure Release of the Rail

The rail 10 or the common high-pressure storage volume 12, 15 of the injectors 1 is relieved of high pressure by switching a pressure control valve 13 connected to the rail 10 at time to, via which the fuel is returned from the rail 10 to the tank 14. As a result, the pressure in the rail 10 drops to the tank pressure (ambient pressure) at time t1. This is the same as the case without a safety valve (shown in FIG. 7).

In the case of an injector 1 with safety valve 6, however, the safety valve body 61 now moves upwards due to the pressure difference between the rail and the injector and fuel can flow out of the injector 1 into the rail 10. As a result, only a very small pressure difference acts across the safety valve seat 62. Mechanical damage and danger to people are thus safely and reliably prevented by a purely mechanical valve.

### Phase C: End State Reached

The entire system, including the injector 1, is depressurised after a relatively short time (t>t1).

The injector can thus be dismantled safely without any danger to people. The injector remains undamaged.

FIG. 9 shows an embodiment of the injector according to the invention without the function of a flow limiter. In contrast to the illustration in FIG. 2, there is at least one feed-through 20 in the lower stop 18, which cannot be sealed by fitting the primary valve body 51.

FIGS. 10a-d show different approaches to the arrangement of these two valves in a configuration in which the pressure relief valve 21 is designed separately from the valve for flow limitation 22.

FIG. 10a shows a plurality of identically constructed injectors 1, in the pressure reservoir 25 of which the pressure limiting valve 22 is arranged at the bottom and the pressure relief valve 21 is arranged at the top. The reference numeral 24 indicates the space for the switching valve that comprises the nozzle needle 4. The pressure reservoir 25 and the area for the switching valve 24 are connected via a high-pressure connection 23.

FIG. 10b shows an embodiment in which the pressure relief valve 21 is arranged in the centre of the pressure reservoir 25 and the pressure limiting valve 22 is still located in the lower area.

FIG. 10e shows an embodiment in which both the pressure relief valve 21 and the pressure limiting valve 22 are arranged in the lower area of the pressure reservoir 25, wherein the pressure relief valve 21 is arranged upstream opposite the pressure limiting valve 22.

FIG. 10d shows a further embodiment in which both the pressure relief valve 21 and the pressure limiting valve 22 are arranged in the lower region of the pressure reservoir 25, wherein the pressure limiting valve 22 is arranged upstream opposite the pressure relief valve 21.

FIG. 11 shows that the positioning of the pressure relief valve 21 has an influence on the functional behaviour of an injector 1.

When the pressure relief valve 21 is positioned at the top of the pressure reservoir 25 (see FIG. 10a), the injector currently injecting cannot access the high-pressure volume of the injectors 1 connected via the fuel line 11, but only its own or a connected rail 10, if provided. This can lead to a sharp drop in pressure in the injector 1 during injection and thus to a drop in the injection rate (undesirable loss of power). This can be seen in the diagram shown in FIG. 11 by the dotted line.

When positioned at the bottom (see FIG. 10e), during injection in the opening phase of the injector 1—after an initially normal injection process—there may be an interim drop in the rate compared to the normal injection process, as the pressure relief valve 21 (PRV) initially blocks the fuel flow and only opens when a pressure difference of ρrail−ρinjector≥ΔρPRV is reached. Due to the mass inertia and the hydraulic balance of forces, opening takes place in a short but not insignificant amount of time. During this time, in which the pressure limiting valve insert at the upper stop is still restricting the flow of fuel, there is a drop in pressure in the injector volume (switching valve volume+pressure limiting valve volume), and thus a drop in the rate. As soon as the pressure relief valve is opened far enough, the system adjusts to the normal injection rate.

Positioning at the bottom of the pressure reservoir allows a combined design of pressure relief valve and pressure limiting valve and is also considered advantageous in terms of performance. This is also the preferred variant shown in this patent. When positioned in the centre of the pressure reservoir, the advantages of the two previous positions can be combined and their disadvantages eliminated or reduced.

An influence on the rate curve can be largely avoided.

The disadvantage here is that the pressure relief valve usually has to be designed as a separate assembly. In addition, a combined design would lead to an undesirable reduction in the pressure reservoir (displacement of the fluid volume by the component volume).

1. Fuel injector for injecting a fuel into a combustion chamber of an internal combustion engine, comprising:
a feed opening for feeding in fuel,
at least one outlet opening for outputting the fuel,
a nozzle needle that is movable between a closed position, in which the at least one outlet opening is closed, and an open position, in which the at least one outlet opening is opened, and
a primary valve arranged downstream of the feed opening and upstream of the nozzle needle and designed to establish a fluid connection between the feed opening and the nozzle needle only when a positive pressure is exceeded by a region upstream of the primary valve with respect to a region downstream of the primary valve,
comprising
a safety valve arranged downstream of the feed opening and upstream of the nozzle needle and designed to establish a fluid connection between the feed opening and the nozzle needle only when a positive pressure is exceeded by a region downstream of the safety valve with respect to a region upstream of the safety valve.

2. Fuel injector according to claim 1, wherein the primary valve comprises a movable primary valve body, a primary valve seat sealable by the primary valve body and an elastic clamping element for forcing the primary valve body in the direction of the primary valve seat, and/or
the safety valve comprises a movable safety valve body, a safety valve seat sealable by the safety valve body and an elastic clamping element for forcing the safety valve body in the direction of the safety valve seat.

3. Fuel injector according to claim 2, wherein the primary valve seat is arranged on a stop part that has at least one feed-through that can be closed or released by the primary valve body, and wherein the stop part has at least one second feed-through that cannot be closed by the primary valve body and that can only be closed or released by means of the safety valve.

4. Fuel injector according to claim 3, wherein the safety valve is integrated into the stop part, cooperates with it and/or forms it in conjunction with an elastic clamping element.

5. Fuel injector according to claim 1, wherein
the safety valve generates a sealing effect by means of a safety valve body in the form of a ball and a safety valve seat designed as a ball seat or conical seat, or
the safety valve generates a sealing effect by means of a safety valve body in the form of a cone and a safety valve seat designed as a conical seat.

6. Fuel injector according to claim 1, wherein the safety valve body is designed in one, two or more parts.

7. Fuel injector according to claim 1, wherein the clamping element of the primary valve forces the primary valve body in a direction opposite to that in which the clamping element of the safety valve forces the safety valve body.

8. Fuel injector according to claim 1, wherein the safety valve is arranged upstream of the primary valve.

9. Fuel injector according to claim 1, wherein the primary valve body is in contact with the safety valve body in a closed position, in which its associated resilient clamping element forces it, and seals a feed-through of the safety valve body.

10. Fuel injector according to claim 1, wherein the primary valve is further configured to restrict a flow of a fuel introduced from the feed opening towards the at least one outlet opening, preferably wherein the outflow of fuel downstream of the primary valve results in a pressure gradient being created to move a primary valve body in a direction opposite to its primary valve seat so that it comes into contact with a second downstream primary valve seat and stops the flow from the feed opening to the at least one outlet opening.

11. Fuel injector according to claim 2, wherein the primary valve body and/or the safety valve body has at least one feed-through for passing fuel from an upstream section to a downstream section or vice versa.

12. Fuel injector according to claim 11, wherein the at least one feed-through for passing fuel of the primary valve body is arranged offset to the associated elastic clamping element, such that a fluid flow flowing through the feed-through is not guided through windings of the elastic clamping element.

13. Internal combustion engine, having at least one fuel injector according to claim 1.

14. Internal combustion engine according to claim 13, wherein a plurality of fuel injectors is connected to a common high-pressure volume and thus indirectly connected to one another.

15. Internal combustion engine according to claim 13, wherein a plurality of fuel injectors is directly connected to one another via fuel lines and each have a high-pressure storage volume, which they share with the other fuel injectors via the connection through the fuel lines.

16. Fuel injector according to claim 7 wherein the two directions are aligned antiparallel to each other.

17. Fuel injector according to claim 9, wherein the clamping element of the primary valve and the clamping element of the safety valve each exert a force to press the primary valve body and the safety valve body against each other.

18. Fuel injector according to claim 17, wherein, the force exerted by the clamping element of the safety valve is greater than that of the clamping element of the primary valve.
